(19) United States
(12) Patent Application Publication
(10) Pub. No.: US 2020/0042814 A1
(43) Pub. Date: Feb. 6, 2020

(54) DETECTION METHOD AND FINGERPRINT SENSING DEVICE

(71) Applicant: AU Optronics Corporation, Hsin-Chu (TW)

(72) Inventors: Sheng-Yun CHANG, HSIN-CHU (TW); Ren-Jie PAN, HSIN-CHU (TW); Sin-Guo JHOU, HSIN-CHU (TW); Che-Hsien CHEN, HSIN-CHU (TW)

(21) Appl. No.: 16/392,134

(22) Filed: Apr. 23, 2019

(30) Foreign Application Priority Data
Jul. 31, 2018 (TW) 107126557

(51) Int. Cl. G06K 9/03; G06K 9/00

(52) U.S. Cl. CPC G06K 9/03; G06K 9/0002

(57) ABSTRACT

A detection method is disclosed. The detection method is configured to detect a fingerprint sensing device, in which the fingerprint sensing device includes several sensing electrodes arranged in a matrix, in which the detection method includes: outputting several gate signals to several sensing electrodes through a plurality of gate lines; outputting a plurality of sensing values of several sensing electrodes according to a sensing interval of each of several gate signals; and determining whether a defect exists in the fingerprint sensing device or not according to several sensing values, in which a first gate signal of several gate signals is transmitted to part of several sensing electrodes through a first gate line of several gate lines, and in which the sensing interval of the first gate signal is shorter than the sensing interval of each of the rest of several gate signals.

### CROSS-REFERENCE TO RELATED APPLICATION

This application claims the priority benefit of TAIWAN Application serial no. 107126557, filed Jul. 31, 2018, the full disclosure of which is incorporated herein by reference.

### FIELD OF INVENTION

The invention relates to a detection method and a fingerprint sensing device. More particularly, the invention relates to a detection method and a fingerprint sensing device corresponding to a defect.

### BACKGROUND

The fingerprint sensing device includes a detection circuit and sensing electrodes arranged in a two-dimensional array. When using, the detection circuit applies driving signals to each sensing electrode, and the detection circuit receives the detection signals of every sensing electrodes. Each of the sensing electrodes constitutes a primitive of the fingerprint sensing device. In this way, when the finger acts on the fingerprint sensing device, each sensing electrode may detect the voltage change caused by the corresponding point of the fingerprint, so that the depth of the corresponding point of the fingerprint may be described, and the texture of the entire fingerprint is described together with other sensing electrodes to form a fingerprint image.

However, a defect may exist in the sensing electrode itself, which causes a dead pixel at the fingerprint sensing device, and some defect may cause the fingerprint sensing device to overheat. Therefore, the detection of the fingerprint sensing device is very important.

### SUMMARY

An embodiment of this disclosure is to provide a detection method. The detection method is configured to detect a fingerprint sensing device, in which the fingerprint sensing device includes several sensing electrodes arranged in a matrix, in which the detection method includes: outputting several gate signals to several sensing electrodes through a plurality of gate lines; outputting a plurality of sensing values of several sensing electrodes according to a sensing interval of each of several gate signals; and determining whether a defect exists in the fingerprint sensing device or not according to several sensing values, in which a first gate signal of several gate signals is transmitted to part of several sensing electrodes through a first gate line of several gate lines, and in which the sensing interval of the first gate signal is shorter than the sensing interval of each of the rest of several gate signals.

An embodiment of this disclosure is to provide a fingerprint sensing device. The finger print sensing device includes several sensing electrodes, several gate lines, several sensing lines, a gate driver, several sensing chips, and a controller. Several gate lines are coupled to part of several sensing electrodes respectively. Several sensing lines are coupled to part of the sensing electrodes respectively. The gate driver is configured to output several gate signals to several sensing electrodes through several gate lines. Several sensing chips are configured to receive several sensing values of several sensing electrodes according to a sensing interval of each of several gate signals. The controller is coupled to several sensing chips and the gate driver, and the controller is configured to determine whether a defect exists in the fingerprint sensing device or not according to several sensing values. A first gate signal of several gate signals is transmitted to part of several sensing electrodes through a first gate line of several gate lines, and in which the sensing interval of the first gate signal is shorter than the sensing interval of each of the rest of several gate signals.

Therefore, according to the technical concept of the present invention, embodiments of this disclosure are to provide a detection method and a fingerprint sensing device. More particularly, the invention relates to a detection method and a fingerprint sensing device corresponding to a defect. By adjusting the sensing clocks of the boundary area of the fingerprint sensor, the interference of the finger pressing or other sensing objects are eliminated, and the detection of the fingerprint sensing device may be effectively performed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a fingerprint sensing device according to some embodiments of the present disclosure.

FIG. 2 is a diagram illustrating a driving waveform of the fingerprint sensing device according to some embodiments of the present disclosure.

FIG. 3 is a diagram illustrating a sensing electrode according to some embodiments of the present disclosure.

FIG. 4 is a diagram illustrating a sensing chip according to some embodiments of the present disclosure.

FIG. 5 is an operation diagram of the fingerprint sensing device according to some embodiments of the present disclosure.

FIG. 6 is a sensing chart of the fingerprint sensing device according to some embodiments of the present disclosure.

FIG. 7 is a flow chart illustrating a detection method according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

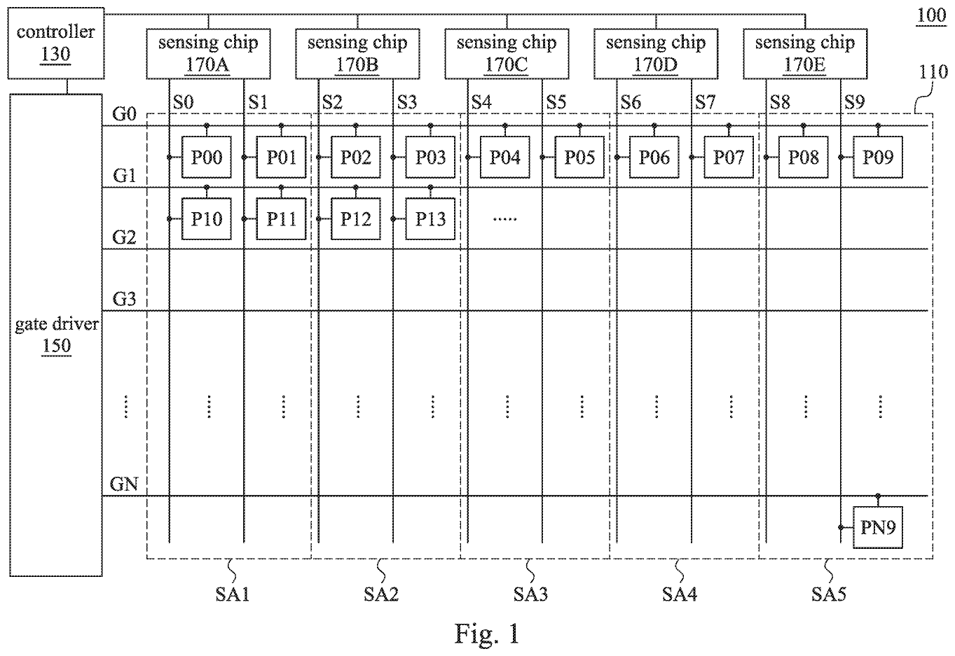

Reference is made to FIG. 1. FIG. 1 is a schematic diagram illustrating a fingerprint sensing device 100 according to some embodiments of the present disclosure. As illustrated in FIG. 1, the fingerprint sensing device 100 includes an active area 110, a controller 130, a gate driver 150, several sensing chips 170A-170E, and several gate lines G0-GN, and several sensing lines S0-S9. The active area 110 includes several sensing electrodes P00-PN9. In the connection relationship, the controller 130 couples to several sensing chips 170A-170E and the gate driver 150. The gate driver 150 couples to several gate lines G0-GN. The sensing chips 170A-170E couple to part of the sensing lines S0-S9 respectively. For example, the sensing chip 170A couples to the sensing lines S0 and S1, the sensing chip 170B couples to the sensing lines S2 and S3, and so on. Each of the several sensing electrodes P00-PN9 couples to one of the sensing lines S0-S9 and one of the gate lines G0-GN. For example, the sensing electrode P00 couples to the gate line G0 and the sensing line S0, the sensing electrode P01 couples to the gate line G0 and the sensing line S1, and so on.

Furthermore, the active area 110 further includes several sensing areas SA1-SA5, and each of the several sensing areas SA1-SA5 includes part of the sensing electrodes P00-PN9. For example, the sensing area SA1 includes at least sensing electrodes P00 and P01, the sensing area SA2 includes at least sensing electrodes P02 and P03, and so on.

Each of the sensing areas SA1-SA5 corresponds to one of the sensing chips 170A-170E. For example, the sensing area SA1 corresponds to the sensing chip 170A, the sensing area SA2 corresponds to the sensing chip 170B, and so on.

It should be noted that, the fingerprint sensing device 100 as illustrated in FIG. 1 is for illustrative purposes only. For example, the number of the sensing chips, the number of the sensing areas, the number of the sensing electrodes included in each of the sensing areas, the number of the sensing lines, the number of the sensing electrodes and the number of the gate lines as illustrated in FIG. 1 are for illustrative purposes only, and the present disclosure is not limited thereto.

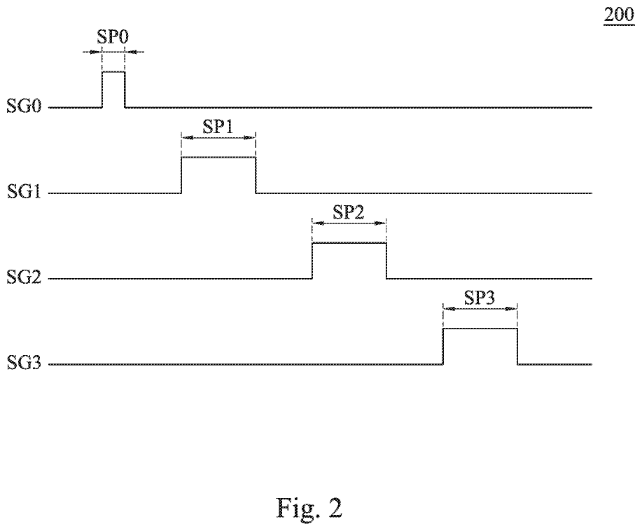

In the operational relationship, reference is made to FIG. 2 together. FIG. 2 is a diagram illustrating a driving waveform 200 of the fingerprint sensing device 100 according to some embodiments of the present disclosure. Each of the sensing electrodes P00-PN9 produces sensing values. The gate driver 150 outputs gate signal to the gate lines G0-GN, for example, the gate driver 150 outputs the gate signal SG0 to the gate line G0, the gate line G0 further transmits the gate signal SG0 to the sensing electrodes coupled to the gate line G0 (for example, the sensing electrodes P00-P09), the gate driver 150 outputs the gate signal SG1 to the gate line G1, the gate line G1 further outputs the gate signal SG1 to the sensing electrodes coupled to the gate line G1 (for example, sensing electrodes P10-P13, etc.), and so on.

Each of the gate signals SG0-SG3 includes the sensing intervals SP0-SP3. During the sensing intervals SP0-SP3, parts of the sensing electrodes P00-PN9 transmit sensing values to one of the sensing chips 170A-170E respectively. For example, during the sensing interval SP1, the sensing electrodes P10 and P11 coupled to the gate line G1 transmit sensing values to the sensing chip 170A respectively, the sensing electrodes P12 and P13 coupled to the gate line G1 transmit sensing values to the sensing chip 170B respectively, and so on.

As illustrated in FIG. 2. The sensing interval SP0 of the gate signal SG0 is shorter than all of the sensing intervals SP1-SP3 of the rest of the gate signals SG1-SG3. In some embodiments, the time lengths of the sensing intervals SP1-SP3 are the same. It should be noted that, for ease of explanation, in FIG. 2, only the gate signals SG0-SG3 output to the gate lines G0-G3 are illustrated, however, the sensing interval output to the rest of the gate lines and the sensing intervals SP1-SP3 of the gate signals SG1-SG3 include the same time length.

In some embodiments, the time length of the sensing interval SP0 is 8 clock cycles, and the time length of the sensing intervals SP1-SP3 is 220 clock cycles. The clock cycle is the clock cycle input to the gate driver 150 of the controller 130 (not illustrated). The time length of the sensing interval mentioning above is for illustrative purposes only, the embodiments of the present disclosure is not limited thereto. It should be noted that, the time length of the sensing interval should not be 0. If the time length of the sensing interval is 0, the error of the clock signal may be caused.

In some embodiments, the gate signal SG0 is transmitted to the gate line, which is closest to the fingerprint sensing device 100, of the gate lines G0-GN. For example, the gate signal SG0 is transmitted to the gate line G0, which is located at the boundary of the fingerprint sensing device 100 as illustrated in FIG. 1. In some other embodiments, the gate signal SG0 may also be transmitted to the gate line GN which is located at the boundary of the fingerprint sensing device 100 as illustrated in FIG. 1.

After the sensing chips 170A-170E receive the sensing values, the sensing chips 170A-170E transmit the sensing values to the controller 130. Then, the controller 130 determines whether a defect exists in the fingerprint sensing device 100 or not according to the sensing values.

Since the sensing interval SP0 of the gate signal SG0 is short, the sensing electrodes P01-P09 coupled to the gate line G0 are unable to transmit the sensing values to the sensing chips 170A-170E. Therefore, data transmitted to the sensing chips 170A-170E from the sensing electrodes P01-P09 coupled to the gate line G0 may be the data of the sensing electrodes P01-P09 themselves but not the sensing values detected by the sensing electrodes P01-P09. In this way, when determining whether a defect exists in the sensing areas SA1-SA5 or not, the determination may not be affected by the sensing object, and whether a defect exists in the sensing areas SA1-SA5 or not may be determined by obtaining the data of the sensing electrodes P01-P09 themselves. Moreover, in the embodiments of the present disclosure, the shortened sensing interval is transmitted to the gate line closest to the boundary of the fingerprint sensing device 100, and the influence to the detecting function of the fingerprint sensing device 100 may be smaller.

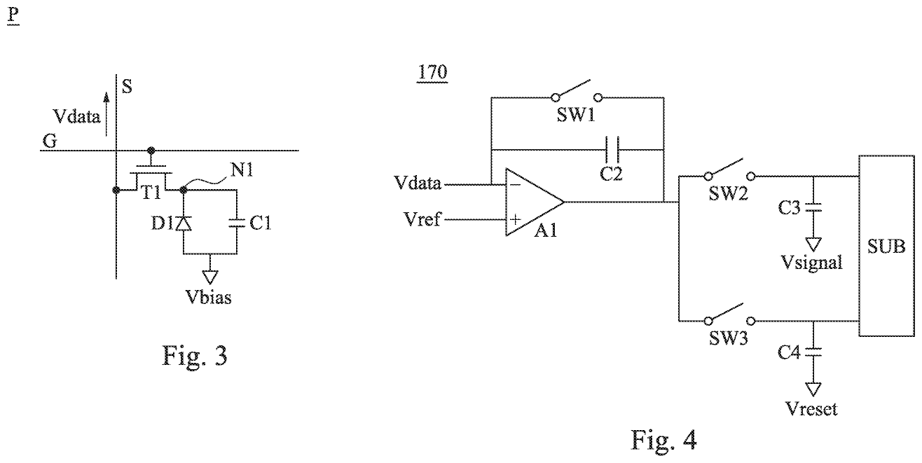

Reference is made to FIG. 3. FIG. 3 is a diagram illustrating a sensing electrode P according to some embodiments of the present disclosure. The sensing electrodes P00-PN9 as illustrated in FIG. 1 may be implemented by the sensing electrode P as illustrated in FIG. 3. The sensing electrode P includes a transistor T1, a diode D1, and a capacitor C1. The gate line G may be one of the gate lines G0-GN in FIG. 1, and the sensing line S may be one of the sensing lines S0-S9 in FIG. 1.

In the connection relationship, the control terminal of the transistor T1 is coupled to the gate line G, the first terminal of the transistor T1 is coupled to the sensing line S. The second terminal of the transistor T1 is coupled to the first terminal of the diode D1 and the first terminal of the capacitor C1 at the node N1, and the second terminal of the diode D1 and the second terminal of the capacitor C1 are coupled to the voltage Vbias. In the operational relationship, when the sensing electrode P is shading by an object, the light detected by the sensing electrode P is less, and there is less leakage at the diode D1, and the voltage drop of the node N1 is less, in which the node N1 is connected to the first terminal of the capacitor C1, the first terminal of the diode D1, and the second terminal of the transistor T1. On the contrary, when the light detected by the sensing electrode P increases, the voltage drop at the node N1 is more. When the gate signal transmitted by the gate line G makes the transistor T1 conducted, the voltage value at the second terminal of the transistor T1 is transmitted to the first terminal of the transistor T1 through the transistor T1, and the voltage value is transmitted to the sensing chip coupled to the sensing line S through the sensing line S.

Reference is made to FIG. 4. FIG. 4 is a diagram illustrating a sensing chip 170 according to some embodiments of the present disclosure. The sensing chip 170 illustrated in FIG. 4 may be configured to represent the sensing chips 170A-170E illustrated in FIG. 1. The sensing chip 170 includes switches SW1-SW3, the comparator A1, the microcontroller SUB, and the capacitors C2-C4. In the connection relationship, the first terminal of the comparator A1 is configured to receive the reference voltage Vref. The second terminal of the comparator A1 is coupled to the first terminal of the capacitor C2 and the first terminal of the switch SW1. The output terminal of the comparator A1 is coupled to the second terminal of the capacitor C2 and the second terminal of the switch SW1. The first terminal of the switch SW2 is coupled to the first terminal of the switch SW3. The second terminal of the switch SW2 is coupled to the first terminal of the capacitor C3 and the microcontroller SUB. The second terminal of the switch SW3 is coupled to the first terminal of the capacitor C4 and the microcontroller SUB. The second terminal of the capacitor C3 is configured to receive the voltage Vsignal, and the second terminal of the capacitor C4 is configured to receive the voltage Vreset.

When the sensing electrode P generates a defect due to scratches or other reasons, the sensing electrode P may be short, which causes the voltage of the sensing value becomes incorrect, and the gray scale value calculated according to the sensing value is decreased.

In the operational relationship, after the comparator A1 receives the sensing value Vdata transmitted by the sensing electrode P as illustrated in FIG. 3, the sensing value is amplified through the comparator A1 and the capacitor C2, and the sensing value is then transmitted to the microcontroller SUB through the switch SW2. The microcontroller SUB transmits the sensing value to the controller 130 as illustrated in FIG. 1.

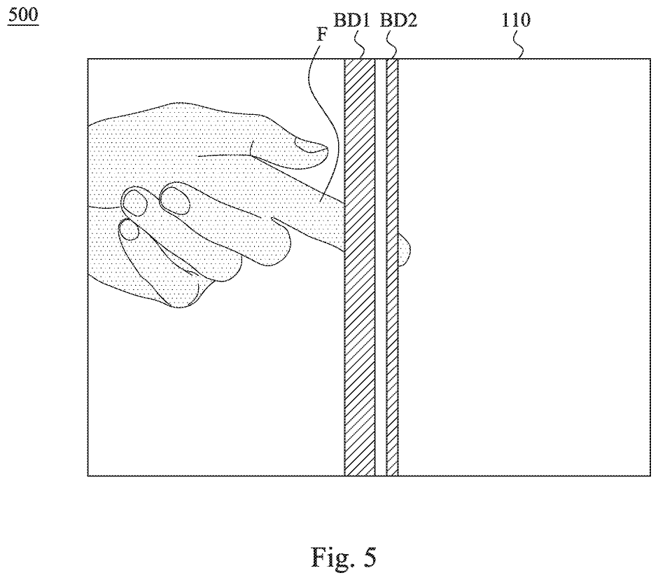

Reference is made to FIG. 5. FIG. 5 is an operation diagram 500 of the fingerprint sensing device 100 according to some embodiments of the present disclosure. As illustrated in FIG. 5, defect sections BD1 and BD2 are gray lines caused by the defect of the fingerprint sensing device 100 itself, and the finger F is the sensing object. For example, the defect mentioning above may be caused by the surface scratches of the fingerprint sensing device 100. The finger F and a gray line of the defect sections BD1 and BD2 may cause the sensing value sensed by the sensing electrodes P00-PN9 as illustrated in FIG. 1 changes.

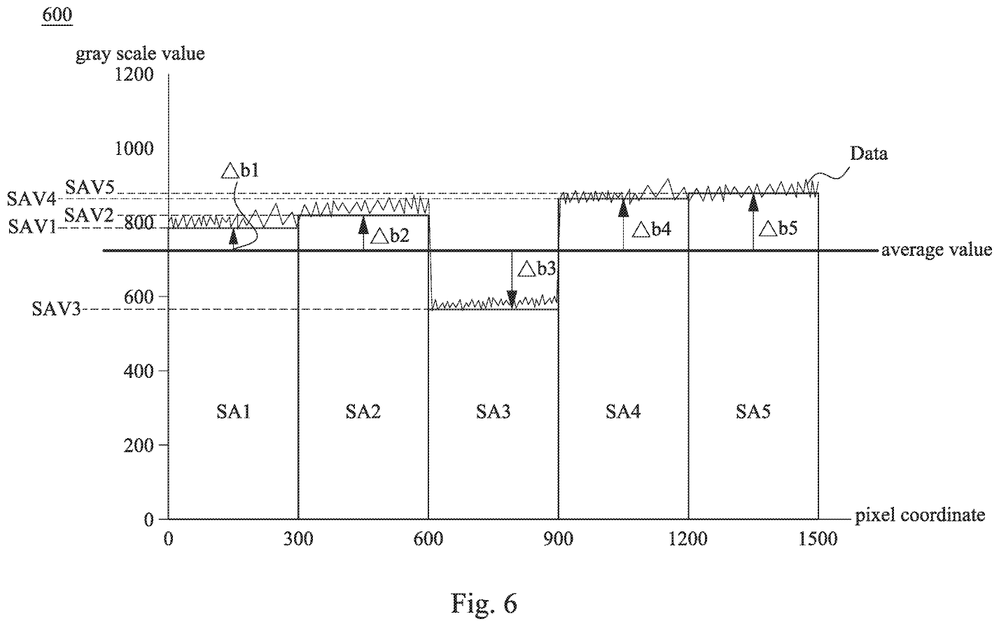

As illustrated in FIG. 6. FIG. 6 is a sensing chart 600 of the fingerprint sensing device 100 according to some embodiments of the present disclosure. The pixel coordinates described on the horizontal axis may correspond to the coordinate position of the horizontal axis of the fingerprint sensing device 100 as shown in FIG. 1. The values of the coordinate positions as shown in FIG. 6 are for illustrative purposes only, and the embodiments of the present invention are not limited thereto.

The sensing value curve Data represents gray scale values correspond to the sensing values transmitted to the sensing chips 170A-170E by the sensing electrodes P00-P09. The gray scale value SAV1 is the gray scale value of the sensing area SA1 as illustrate in FIG. 1, and the gray scale value SAV2 is the gray scale value of the sensing area SA2 as illustrated in FIG. 1, and so on. In some embodiments, the gray scale value SAV1 may be the smallest value or the average value of the several gray scale values of the sensing area SA1. In some embodiments, the gray scale value of the sensing value curve Data is obtained by the controller 130 in FIG. 1, in which the controller 130 calculates the gray scale value according to the sensing value of the several sensing chips 170A-170E.

Reference is made to FIG. 1 and FIG. 6 together. After the controller 130 receives several gray scale values SAV1-SAV5 transmitted by the several sensing chips 170A-170E, the controller 130 calculates the average value of several gray scale values SAV1-SAV5 according to the several gray scale values SAV1-SAV5. Then, the controller 130 determines whether the several gray scale difference values between the several gray scale values and the average value are larger than the gray scale difference value threshold or not. When one of the several gray scale difference values is larger than the gray scale difference value threshold, the controller 130 determines that a defect exists in the fingerprint sensing device 100.

For example, as illustrated in FIG. 6, the gray scale difference value Δb1 is the difference value between the gray scale value SAV1 and the average value, the gray scale difference value Δb1 is the difference value between the gray scale value SAV1 and the average value, and so on. Between several gray scale difference values Δb1-Δb5, the controller 130 determines that the gray scale difference value Δb3 is larger than the gray scale difference value threshold. At this time, the controller 130 determines that a defect exists in the fingerprint sensing device 100. In some embodiments, the fingerprint sensing device 100 further determines that at where of the fingerprint sensing device 100 the defect exists. Reference is made to FIG. 1. For example, the fingerprint sensing device 100 determines that a defect exists at the location of the sensing area SA3 corresponding to the gray scale difference value Δb3.

In some embodiments, when the controller 130 determines that a defect exists in the fingerprint sensing device 100, the controller 130 transmits a notification message to the host (not shown), so as to notify the manufacturer or the user that a defect exists at the fingerprint sensing device 100. In some embodiments, the controller 130 further notifies the manufacturer or the user the pixel coordinates of the defected sensing electrode(s) of the fingerprint sensing device 100 through the notification message.

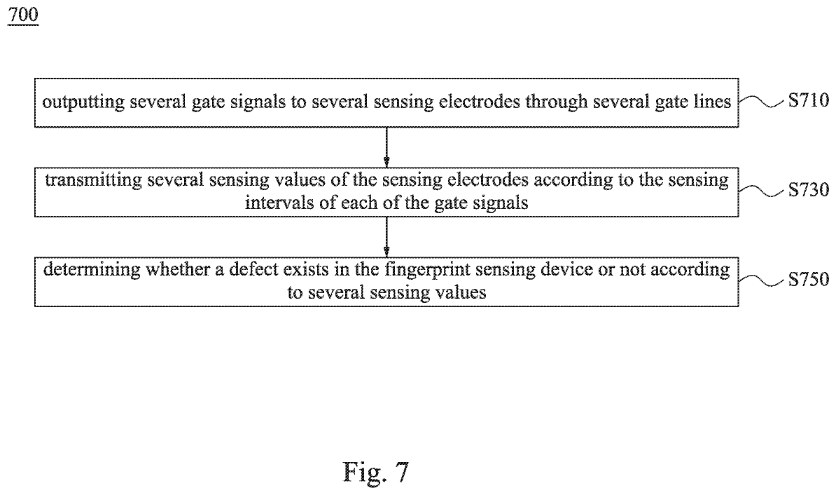

Reference is made to FIG. 7. FIG. 7 is a flow chart illustrating a detection method 700 according to some embodiments of the present disclosure. As illustrated in FIG. 7, the detection method 700 includes the following operations:

Operation S710: outputting several gate signals to several sensing electrodes through several gate lines;

Operation S730: transmitting several sensing values of the sensing electrodes according to the sensing intervals of each of the gate signals; and

Operation S750: determining whether a defect exists in the fingerprint sensing device or not according to several sensing values.

In order to make the detection method 700 of the embodiments of the present disclosure to be easy to understand, reference is made to FIG. 1.

In operation S710, outputting several gate signals to several sensing electrodes through several gate lines. In some embodiments, operation S710 may be operated by the gate driver 150 in FIG. 1. For example, as illustrated in FIG. 1, the gate line G0 is coupled to the sensing electrodes P01-P09. The gate driver 150 transmits the gate signal SG0 as illustrated in FIG. 2 to the gate line G0. The gate line G0 then transmits the gate signal SG0 to the sensing electrodes P01-P09. Reference is made to FIG. 2, within an update time of a frame, each of the several gate signals G0-G3 includes sensing intervals SP0-SP3 sequentially. As illustrated in FIG. 2, the sensing interval SP0 is shorter than every one of the sensing intervals SP1-SP3.

In operation S730, transmitting several sensing values of the sensing electrodes according to the sensing intervals of each of the gate signals. In some embodiments, operation S730 may be operated by the sensing electrodes P00-PN9 as illustrated in FIG. 1. For example, during the sensing interval SP1, each of the sensing electrodes P10 and P11 coupled to the gate line G1 transmits the sensing values to the sensing chip 170A. Each of the sensing electrodes P12 and P13 coupled to the gate line G1 transmits a sensing value to the sensing chip 170B, and so on.

In operation S750, determining whether a defect exists in the fingerprint sensing device or not according to several sensing values. In some embodiments, operation S750 may be operated by the controller 130 in FIG. 1. For example, after the sensing chips 170A-170E receive the sensing values transmitted by the sensing electrodes P00-PN9, the sensing chips 170A-170E transmit the sensing values to the controller 130. The controller 130 calculates to obtain the gray scale values correspond to the sensing values according to the sensing values transmitted by the sensing chips 170A-170E. The controller 130 calculates the average value of several gray scale values according to several gray scale values. Then, the controller 130 determines whether the several gray scale difference values between the several gray scale values and the average value are larger than the gray scale difference value threshold or not. When one of the several gray scale difference values is larger than the gray scale difference value threshold, the controller 130 determines that a defect exists in the fingerprint sensing device 100.

It may be known from the above, since the sensing interval SP0 of the gate signal SG0 is shorter, there is not enough time for the sensing electrodes P01-P09 coupled to the gate line G0 to transmit the sensing values to the sensing chips 170A-170E. Therefore, the data transmitted from the sensing electrodes P01-P09 coupled to the gate line G0 to the sensing chips 170A-170E are data of the sensing electrodes P01-P09 themselves but not the sensing values detected by the sensing electrodes P01-P09. In this way, when determining whether a defect exists in the sensing areas SA1-SA5 or not, the determination is not affected by the sensing object, whether a defect exists in the sensing areas SA1-SA5 or not may be determined by obtaining the data of the sensing electrodes P01-P09 themselves. Furthermore, in the embodiments of the present disclosure, the shortened sensing interval is transmitted to the gate line closest to the boundary of the fingerprint sensing device 100, and the sensing function of the fingerprint sensing device 100 may not be influenced.

It may be known from the embodiments mentioning above, the embodiments of the present disclosure provides a detection method and a fingerprint sensing device, particularly, a detection method and a fingerprint sensing device corresponding to a defect. By adjusting the sensing clocks of the boundary area of the fingerprint sensor, the interference of the finger pressing or other sensing objects are eliminated, and the detection of the fingerprint sensing device may be effectively performed.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one unit from another. For example, a first unit could be termed a second element, and, similarly, a second unit could be termed a first element, without departing from the scope of the embodiments. As used herein, the term “and/or” includes any and all combinations of one or more of the associated listed items.

In addition, the above illustrations include sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A detection method, configured to detect a fingerprint sensing device, wherein the fingerprint sensing device comprises a plurality of sensing electrodes arranged in a matrix, wherein the detection method comprises:
outputting a plurality of gate signals to the plurality of sensing electrodes through a plurality of gate lines;
outputting a plurality of sensing values of the plurality of sensing electrodes according to a sensing interval of each of the plurality of gate signals; and
determining whether a defect exists in the fingerprint sensing device or not according to the plurality of sensing values,
wherein a first gate signal of the plurality of gate signals is transmitted to part of the plurality of sensing electrodes through a first gate line of the plurality of gate lines, and wherein the sensing interval of the first gate signal is shorter than the sensing interval of each of the rest of the plurality of gate signals.

2. The detection method of claim 1, wherein the first gate line is one of the plurality of gate lines closest to a boundary of the fingerprint sensing device.

3. The detection method of claim 1, wherein the sensing interval of the first gate signal is 8 clock cycles, and the sensing interval of each of the rest of the plurality of gate signals is 220 clock cycles.

4. The detection method of claim 1, wherein the fingerprint sensing device comprises a plurality of sensing areas, and each of the plurality of sensing areas comprises part of the plurality of sensing electrodes, wherein determining whether the defect exists in the fingerprint sensing device or not according to the plurality of sensing values comprising:
calculating a plurality of gray scale values of the plurality of sensing areas according to the plurality of sensing values of the plurality of sensing electrodes;
calculating an average value according to the plurality of gray scale values;
determining whether a plurality of gray scale difference values between the plurality of gray scale values and the average value are larger than a gray scale difference value threshold or not; and
determining that the defect exists in the fingerprint sensing device when one of the plurality of gray scale difference values is larger than the gray scale difference value threshold.

5. The detection method of claim 1, further comprising:
transmitting a notification message to a host when it is determined that the defect exists in the fingerprint sensing device.

6. A fingerprint sensing device, comprising:
a plurality of sensing electrodes;
a plurality of gate lines, coupled to part of the plurality of sensing electrodes respectively;
a plurality of sensing lines, coupled to part of the sensing electrodes respectively;
a gate driver, configured to output a plurality of gate signals to the plurality of sensing electrodes through the plurality of gate lines;
a plurality of sensing chips, configured to receive the plurality of sensing values of the plurality of sensing electrodes according to a sensing interval of each of the plurality of gate signals; and
a controller, coupled to the plurality of sensing chips and the gate driver, wherein the controller is configured to determine whether a defect exists in the fingerprint sensing device or not according to the plurality of sensing values,
wherein a first gate signal of the plurality of gate signals is transmitted to part of the plurality of sensing electrodes through a first gate line of the plurality of gate lines, and wherein the sensing interval of the first gate signal is shorter than the sensing interval of each of the rest of the plurality of gate signals.

7. The fingerprint sensing device of claim 6, wherein the first gate line is one of the plurality of gate lines closest to a boundary of the fingerprint sensing device.

8. The fingerprint sensing device of claim 6, wherein the sensing interval of the first gate signal is 8 clock cycles, and the sensing interval of each of the rest of the plurality of gate signals is 220 clock cycles.

9. The fingerprint sensing device of claim 6, wherein the controller is further configured to calculate a plurality of gray scale values of the plurality of sensing areas according to the plurality of sensing values of the plurality of sensing electrodes, calculating an average value according to the plurality of gray scale values, determining whether a plurality of gray scale difference values between the plurality of gray scale values and the average value are larger than a gray scale difference value threshold or not, and determining that the defect exists in the fingerprint sensing device when one of the plurality of gray scale difference values is larger than the gray scale difference value threshold.

10. The fingerprint sensing device of claim 6, wherein the controller is further configured to transmit a notification message to a host when it is determined that the defect exists in the fingerprint sensing device.
